(19) United States
(12) Patent Application Publication
(10) Pub. No.: US 2025/0168895 A1
(43) Pub. Date: May 22, 2025

(54) SIB-BASED DISTRIBUTED ACCESS FOR SATELLITE SWITCHING WITHOUT L3 MOBILITY

(71) Applicant: Nokia Technologies Oy, Espoo (FI)

(72) Inventors: Enric JUAN, Aalborg (DK); Jeroen WIGARD, Aalborg (DK); Rafhael MEDEIROS DE AMORIM, Aalborg (DK); Jedrzej STANCZAK, Wroclaw (PL)

(21) Appl. No.: 18/932,937

(22) Filed: Oct. 31, 2024

(30) Foreign Application Priority Data
Nov. 2, 2023 (FI) 20236224

(51) Int. Cl. H04W 74/0833; H04B 7/185

(52) U.S. Cl. CPC H04W 74/0833; H04B 7/18541; H04B 7/18558

(57) ABSTRACT

A method, apparatus, and computer-program product are provided. In the context of a method, the method receives, from a first network node via a source satellite, a system information block, wherein the system information block indicates a random access channel opportunity window in which the user equipment should access the first network node or a second network node. The method includes determining, based on the system information block, an access time within the random access channel opportunity window. The method includes transmitting, to the first network node or the second network node via a target satellite, a random access channel preamble at the access time.

### TECHNOLOGICAL FIELD

An example embodiment relates generally to satellite switching without layer 3 mobility and, more particularly, to random access channel-based satellite switching.

### BACKGROUND

User equipment devices which support non-terrestrial networks have global navigation satellite system capabilities. In a non-terrestrial network system, 5G base station (i.e., gNB) functionality may be deployed on board satellites or deployed elsewhere and relayed by satellites in a transparent way to provide communication coverage over a large area that may be otherwise unreachable by cellular networks. This functionality may be used to connect internet-of-things devices globally and provide personal communication in remote areas and in disaster relief.

Low earth orbit satellites orbit approximately 600-1500 kilometers above Earth and move about 7.5 km/s relative to Earth. Low earth orbit satellites typically have a beam footprint radius between 100 and 1000 kilometers. For Earth-fixed cells, the satellite continuously adjusts a satellite beam pointing direction to fix a new radio cell and new radio beam to a specific point on Earth. For Earth-moving cells, a satellite beam pointing direction is fixed and the beam footprint (i.e., new radio cell) is moving on Earth. Additionally, for Earth-moving cells, mobility is mainly due to satellite movement as satellites are moving faster than user equipment devices on the ground.

For an unchanged physical cell identifier, after satellite switching, a serving network node and a cell on ground does not change. Therefore, a majority of the cell configuration may be kept without changing the physical cell identifier, frequency, and other cell configuration parameters (e.g., servingCellconfigCommon). A user equipment in this case is not required to perform layer three mobility (i.e., handover procedure), may avoid flushing buffers and does not need to update the security key. In this scenario, non-terrestrial network cells may be deployed as quasi-Earth fixed calls since the cell coverage's area should not change. In addition, the network should indicate to the user equipment how and when to resynchronize after satellite switching, and target satellite information should be provided before satellite switching and via broadcast signaling (no radio resource control dedicated signaling should be used to reduce the Uu interface overhead).

In layer 3 mobility, the network may use different features to spread the user equipment access to a new cell across time (e.g., blind handover, location/time-based conditional handover, random access channel-less handover). That means, by using user equipment-dedicated radio resource control signaling, the network may use different configuration settings to avoid a random access channel storm.

Unchanged primary cell identifier mobility may be performed with and without a random access channel procedure. The unchanged primary cell identifier mobility is described as a situation where, from the user equipment point of view, there is no modification of the cell identification and most of the logical parameters associated to the cell, but the satellite which provides the radio footprint to the cell changes. Physical layer measurements and parameters are modified.

This type of mobility may be deployed for non-geostationary orbits. Specifically, this may be applied for low-earth orbits where satellites may travel up to more than 7000 m/s. As satellites “disappear” on the horizon, there is a need to switch the satellite providing coverage for a given cell. The unchanged primary cell identifier concept is an example of this.

For a hard satellite switching, the incoming satellite does not start radio transmission or reception until the outbound satellite is no longer providing coverage for the cell. For a soft switching, the transmission and/or reception provided by the two satellites may coexist for a period of time.

The user equipment eventually detaches from a source satellite and attach to an incoming satellite during a switch interval. A system information broadcast (or system information block) is used to convey important information to user equipment devices to make the switch.

For a hard satellite switching, because some user equipment devices may not be capable to perform the mobility without the need for random access channel access, the user equipment may need to transmit or receive via a different satellite (e.g., a target satellite). For soft switching, there also may be user equipment devices uncapable of performing the mobility without the random access channel.

In the soft-switching case, the user equipment might need a configured or dynamic uplink grant to be used in the target cell to indicate the switching is completed or to receive a physical downlink shared channel transmitted from the target satellite. The physical downlink shared channel may include an uplink allocation to “shake hands” with the target satellite to indicate the switching is complete. However, user equipment devices may not possess the capability to monitor source and target satellites simultaneously. In such cases, the user equipment may not be capable to receive the physical downlink shared channel transmitted from the target satellite or to acquire the uplink synchronization necessary to proceed through the configured uplink grant while the outbound satellite is still being monitored, as the outbound satellite is still providing coverage and service.

Given that signaling for unchanged physical cell identifier mobility is system information broadcast-based, and considering that several user equipment devices may need to rely on random access channel-based unchanged physical cell identifier, a number of user equipment devices may detach from the source satellite and access the new cell at the same time. This may cause a random access channel storm. As such, there is a need for a method to spread the random access channel access of those user equipment devices without radio resource control signaling.

### BRIEF SUMMARY

In one or more embodiments, a user equipment (110a/110b/110c) is provided, including at least one processor and at least one memory storing instructions that, when executed by the processor, cause the user equipment (110a/110b/110c) to receive (805), from a first network node (112) via a source satellite, a system information block (805a), wherein the system information block (805a) indicates a random access channel opportunity window (855) in which the user equipment (110a/110b/110c) should access the first network node (112) or a second network node. The user equipment (110a/110b/110c) is further caused to determine, based on the system information block (805a), an access time (815/825/840) within the random access channel opportunity window (855). The user equipment (110a/110b/110c) is further caused to transmit (820/830/845), to the first network node (112) or the second network node via a target satellite, a random access channel preamble (820a/830a/845a) at the access time (815/825/840).

In one or more embodiments, a network node (112) is provided, including at least one processor and at least one memory storing instructions that, when executed by the processor, cause the network node (112) to transmit (805), to a user equipment (110a/110b/110c) via a source satellite (114), a system information block (805a), wherein the system information block (805a) indicates a random access channel opportunity window (855) in which the user equipment (110a/110b/110c) should access the network node (112) or another network node (115) via a target satellite (116). Additionally or alternatively, the network node (112) may be caused to receive (820/830/845), from the user equipment (110a/110b/110c) via the target satellite (116), a random access channel preamble (820a/830a/845a) at an access time (815/825/840) within the random access channel opportunity window (855).

In one or more embodiments, a computer-implemented method is provided that is performed by a user equipment (110a/110b/110c) and includes receiving (805), from a first network node (112) via a source satellite (114), a system information block (805a), wherein the system information block (805a) indicates a random access channel opportunity window (855) in which the user equipment (110a/110b/110c) should access the first network node (112) or a second network node. The method further includes determining, based on the system information block (805a), an access time (815/825/840) within the random access channel opportunity window (855). The method further includes transmitting (820/830/845), to the first network node (112) or a second network node (115) and through a target satellite (116), a random access channel preamble (820a/830a/845a) at the access time (815/825/840).

In one or more embodiments, a computer-implemented method is provided that is performed by a network node (112) and includes transmitting (805), to a user equipment (110a/110b/110c) via a source satellite, a system information block (805a), wherein the system information block (805a) indicates a random access channel opportunity window (855) in which the user equipment (110a/110b/110c) should access the network node (112) or another network node (115), via a target satellite (116). Additionally or alternatively, the method includes receiving (820/830/845), from the user equipment (110a/110b/110c) via the target satellite, a random access channel preamble (820a/830a/845a) at an access time (815/825/840) within the random access channel opportunity window (855).

In one or more embodiments, a non-transitory computer readable storage medium is provided including computer instructions that, when executed by a user equipment (110), cause the user equipment (110) to receive (805), from a first network node (112) via a source satellite, a system information block (805a), wherein the system information block (805a) indicates a random access channel opportunity window (855) in which the user equipment (110a/110b/110c) should access the first network node (112) or a second network node. The user equipment (110a/110b/110c) is further caused to determine, based on the system information block (805a), an access time (815/825/840) within the random access channel opportunity window (855). The user equipment (110a/110b/110c) is further caused to transmit (820/830/845), to the first network node (112) or the second network node via a target satellite, a random access channel preamble (820a/830a/845a) at the access time (815/825/840).

In one or more embodiments, a non-transitory computer readable storage medium is provided including computer instructions that, when executed by a network node (112), cause the network node (112) to transmit (805), to a user equipment (110a/110b/110c) via a source satellite, a system information block (805a), wherein the system information block (805a) indicates a random access channel opportunity window (855) in which the user equipment (110a/110b/110c) should access the network node (112) or another network node via a target satellite. Additionally or alternatively, the network node (112) may be caused to receive (820/830/845), from the user equipment (110a/110b/110c) via the target satellite, a random access channel preamble (820a/830a/845a) at an access time (815/825/840) within the random access channel opportunity window (855).

In one or more embodiments, a user equipment (110a/110b/110c) is provided that includers means for receiving (805), from a first network node (112) via a source satellite, a system information block (805a), wherein the system information block (805a) indicates a random access channel opportunity window (855) in which the user equipment (110a/110b/110c) should access the first network node (112) or a second network node. The user equipment (110a/110b/110c) further includes means for determining, based on the system information block (805a), an access time (815/825/840) within the random access channel opportunity window (855). The user equipment (110a/110b/110c) further includes means for transmitting (820/830/845), to the first network node (112) or the second network node via a target satellite, a random access channel preamble (820a/830a/845a) at the access time (815/825/840).

In one or more embodiments, a network node (112) is provided that includes means for transmitting (805), to a user equipment (110a/110b/110c) via a source satellite, a system information block (805a), wherein the system information block (805a) indicates a random access channel opportunity window (855) in which the user equipment (110a/110b/110c) should access the network node (112) or another network node via a target satellite. Additionally or alternatively, the network node (112) includes means for receiving (820/830/845), from the user equipment (110a/110b/110c) via the target satellite, a random access channel preamble (820a/830a/845a) at an access time (815/825/840) within the random access channel opportunity window (855).

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of a system including a user equipment, a network node, a source satellite, and a target satellite configured to communicate at least via uplink and downlink transmission in accordance with an example embodiment of the present disclosure;

FIG. 2 is a block diagram of an example communication system in which the system of FIG. 1 may be deployed in accordance with an example embodiment of the present disclosure;

FIG. 3 is an example architecture of a non-terrestrial network in accordance with previous embodiments;

FIG. 4A-4B illustrate satellite switching scenarios where the serving network node does not change in accordance with previous embodiments;

FIG. 5 is a system information block containing satellite assistance information for non-terrestrial network access in accordance with previous embodiments;

FIG. 6A is a medium access control element including a backoff indicator in accordance with previous embodiments;

FIG. 6B is a table of backoff parameter values in accordance with previous embodiments;

FIG. 7 illustrates a user equipment accessing a target satellite at a particular access time in accordance with example embodiments of the present disclosure;

FIG. 8A is a flow diagram of system information block-based random access with a hard-satellite switching in accordance with example embodiments of the present disclosure;

FIG. 8B is a flow diagram of system information block-based random access with soft-satellite switching in accordance with example embodiments of the present disclosure;

FIG. 9 is a system information block indicating a random access channel opportunity window in accordance with example embodiments of the present disclosure;

FIG. 10 is a flowchart illustrating processes performed by a user equipment in order to transmit a random access channel preamble at an access time in accordance with example embodiments of the present disclosure; and

FIG. 11 is a flowchart illustrating processes performed by a network node in order to receive a random access channel preamble at an access time in accordance with example embodiments of the present disclosure.

### DETAILED DESCRIPTION

Some embodiments of the present disclosure will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term “circuitry” refers to (a) hardware-only circuit implementations (e.g., implementations in analog circuitry and/or digital circuitry); (b) combinations of circuits and computer program product(s) including software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation including one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encored thereon computer-executable instructions or software programs. A non-transitory “computer readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more universal synchronous bus (USB) flash drives), computer system memory or random-access memory (such as dynamic random access memory (DRAM), static random access memory (SRAM), extended data out random access memory (EDO RAM), and the like.

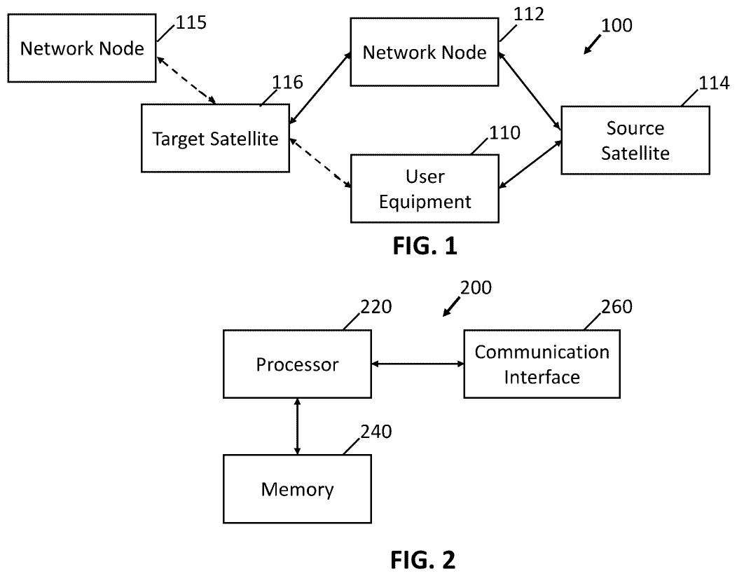

As illustrated in FIG. 1, a system 100 is provided in accordance with an example embodiment in order to distribute times to perform random access channel based handover. Although the system may be configured in various manners, the system of one embodiment is depicted in FIG. 1 and includes user equipment 110, network nodes 112 and 115, source satellite 114, and target satellite 116 configured to communicate via uplink and downlink transmission and reception beams. Although one user equipment, two network nodes, and two satellites are depicted, the system may include and the user equipment 110, network nodes 112 and 115, source satellite 114, and target satellite 116 may communicate with additional user equipment, network nodes, and satellites in other embodiments. For example, target satellite 116 may be connected to a different network node from network nodes 112 and 115. In one or more embodiments, the user equipment 110, network nodes 112 and 115, source satellite 114, and target satellite 116 may be configured to support, for example, 5G, 5G advanced, or 6G. In one or more embodiments, the system 100 may support carrier aggregation and/or dual connectivity. As described below, the system may support paging triggered small data transmission, such as mobile terminated small data transmission and/or mobile originated small data transmission.

The data that is transmitted via the uplink and downlink beams between the user equipment 110, network nodes 112 and 115, source satellite 114, and target satellite 116 may be any of a wide variety of data including, but not limited to digital imagery data including video data, audio data as well as data provided by sensors, radars, telescopes and radio receivers. In at least some instances, the data is encoded prior to communication of the data via the uplink and downlink beams and decoded upon reception. The resulting data received may be utilized for a variety of purposes including presentation to a user, storage of the data for subsequent use and/or provision of the data to one or more applications, such as applications that perform statistical inference on the data for various purposes including object recognition, image classification, spectrum sensing, speech transcription and/or prediction or detection of events.

The user equipment 110 of FIG. 1 (also called UE, user device, user terminal, terminal device, etc.) illustrates a type of an apparatus which resources on an air interface are allocated and assigned. The user equipment 110 typically refers to a portable computing device that includes wireless mobile communication devices operating with or without a subscriber identification module (SIM), including, but not limited to, the following types of devices: a mobile station (mobile phone), smartphone, personal digital assistance (PDA), handset, device using a wireless modem (alarm or measurement device, etc.), laptop and/or touch screen computer, tablet, game console, notebook, and multimedia device. User equipment 110 may also be a device having capability to operate in Internet of Things (IoT) network which is a scenario in which objects are provided with the ability to transfer data over a network without requiring human-to-human or human-to-computer interaction. The user equipment 110 may also be called a subscriber unit, mobile station, remote terminal, access terminal, user terminal, or user equipment (UE) just to mention but a few names or apparatuses. The user equipment 110 may be connected via radio resource control. The user equipment may be in a radio resource control inactive mode or a radio resource control idle mode.

The network nodes 112 and 115 of FIG. 1 may include, for example, base stations such as remote radio heads (RRHs), transmission reception points (TRPs), access points, node Bs (e.g., gNB) or other transmission sources. The network nodes 112 and 115 may be configured to communicate with user equipment 110 via a network.

The source satellite 114 and target satellite 116 may be configured to relay signals from, for example, network nodes 112 or 115 to user equipment 110. The source satellite 114 and target satellite 116 may have a transparent structure in which signals are relayed from the network nodes 112, 115 and/or a different network node to the user equipment 110, or they may have a regenerative structure in which, for example a network node 112 is onboard source satellite 114 and network node 115 is onboard target satellite 116.

FIG. 2 depicts an example apparatus 200 that may be configured to function as user equipment 110 or centralized and distributed network nodes 112-118. As shown in FIG. 2, the apparatus includes, is associated with, or is in communications with processing circuitry 220, a memory 240, and a communication interface 260. The processing circuitry 220 may be in communication with the memory device 240 via a bus for passing information among components of the apparatus. The memory device may be non-transitory and may include, for example, one or more volatile and/or non-volatile memories. In other words, for example, the memory device may be an electronic storage device (e.g., a computer readable storage medium) including gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 200 may, in some embodiments, be embodied in various computing devices described as above. However, in some embodiments, the apparatus may be embodied as a chip or chip set. In other words, the apparatus may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment on a single chip or as a single “system on a chip.” As such, in some cases, a chip or chipset may constitute means for performing one or more operations for providing the functionalities described herein.

The processing circuitry 220, also referenced as a processor, may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining, and/or multithreading.

In an example embodiment, the processing circuitry 220 may be configured to execute instructions stored in the memory device 240 or otherwise accessible to the processing circuitry. Alternatively or additionally, the processing circuitry may be configured to execute hardcoded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processor to perform the algorithms and/or operations described herein when the instructions are executed. However, in some cases, the processing circuitry may be a processor of a specific device (e.g., an image or video processing system) configured to employ an embodiment by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 260 may be any means such as a device or circuitry embodied in either hardware or a combination of hardware and software that is configured to receive and/or transmit data including media content in the form of video or image files, one or more audio tracks or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communications interface may alternatively or also support wired communication. As such, for example, the communication interface may include a communication modem and/or other hardware/software for supporting communication via cable, digital subscriber line (DSL), universal serial bus (USB) or other mechanisms.

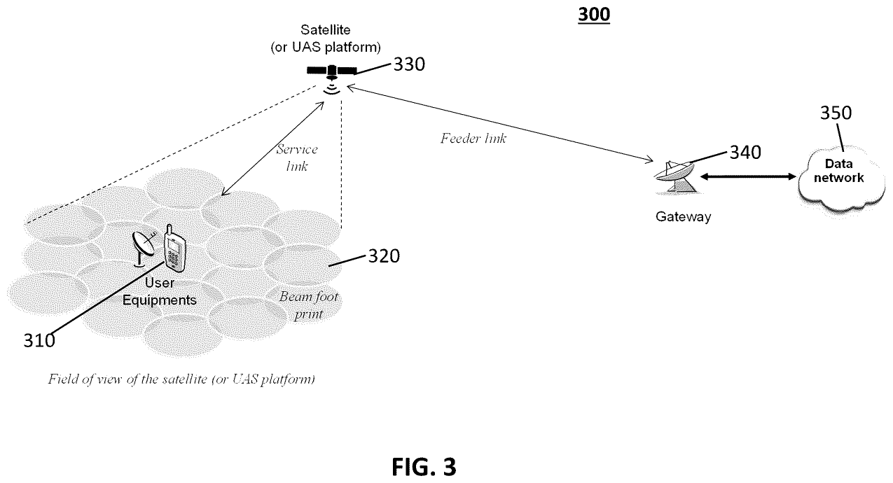

Turning now to FIG. 3, an example illustration of a non-terrestrial network 300 is provided in accordance with previous embodiments. A data network 350 is connected to gateway 340. The gateway 340 transmits signals through a feeder link to satellite 330 (or uncrewed ariel system 330). The signals are relayed through a service link to cover a beam footprint 320. A plurality of beam footprints make up the field view of satellite 330. A user equipment 310 may be moving or stationary on Earth and may exit the field view of satellite 330 into a field view of a different satellite. While in the field view of satellite 330, transmissions from the user equipment 310 may also be relayed through satellite 330 to gateway 340 and data network 350.

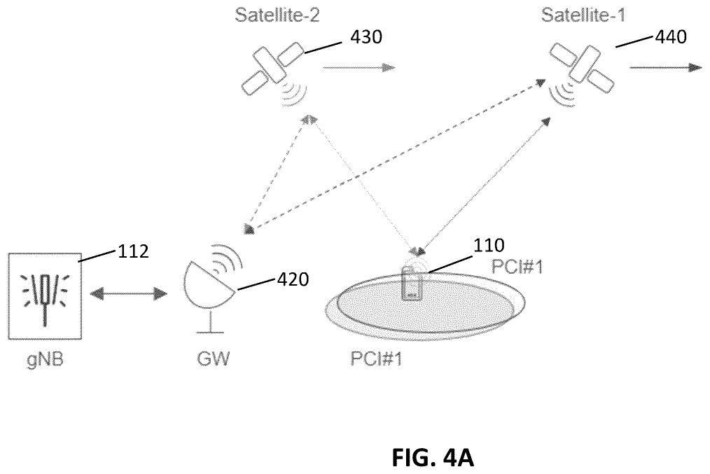

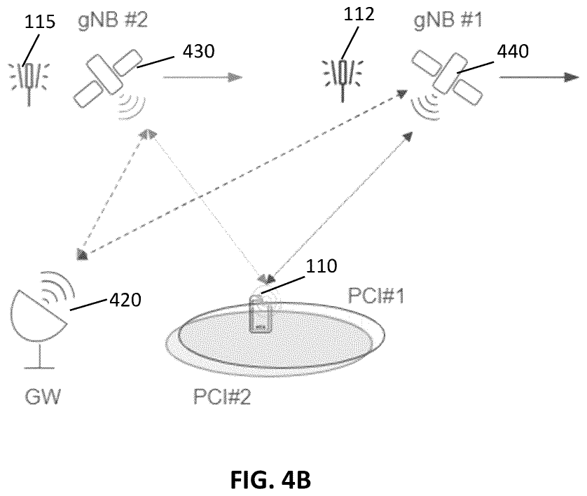

Turning now to FIG. 4A, an example of a satellite switching where a primary cell identifier is unchanged in a transparent-based earth fixed cell deployment in accordance with previous embodiments. In this scenario, user equipment 110 is served by satellite 440. Satellite 440 and satellite 430 each are configured to relay signals from network node 112 transmitted via gateway 420. As satellite 440 moves away from user equipment 110 and satellite 430 moves closer, network node 112 indicates that a satellite switching may occur and how to perform re-synchronization to the new cell. Once satellite 430 takes over serving the area of the user equipment 110, user equipment 110 performs downlink and uplink synchronization operations to re-connect.

Since the user equipment 110 does not change the serving network node 112, it keeps the same cell configuration. Satellites 430 and 440 are configured with the same physical cell identifier, same user equipment context, and same protocol stack (including synchronization signal block generation, coding and decoding, modulation and demodulation, control resource set configuration, and switch routing). However, from the reference point of the user equipment 410, the satellites 430 and 440 introduce different frequency (i.e., Doppler) and timing drifts (the propagation paths towards satellites 430 and 440 are different).

In some cases, the user equipment 110 performs a hard satellite switching, which considers no overlapping between non-terrestrial network cells radiated by satellites 430 and 440. In this case, the user equipment 110 should consider certain interruption time to pre-compensate frequency and timing of the new cell. In other cases, the user equipment 110 performs a soft satellite switching, which considers cell overlapping. In this scenario, it is assumed that satellites 430 and 440 are transmitting synchronization signal blocks at the same time (potentially with the same physical cell identifier but different time and frequency offsets, allowing a user equipment to switch satellites.

Turning now to FIG. 4B, an example is illustrated where satellite 430 is connected to another network node 115 different than network node 112, which is connected to satellite 440. In the example illustrated, the satellites have a regenerative architecture, with network nodes 115 and 112 onboard satellites 430 and 440, respectively. However, a transparent structure would also be possible with network nodes 115 and 112 transmitting signals through gateway 420 to satellites 430 and 440, respectively.

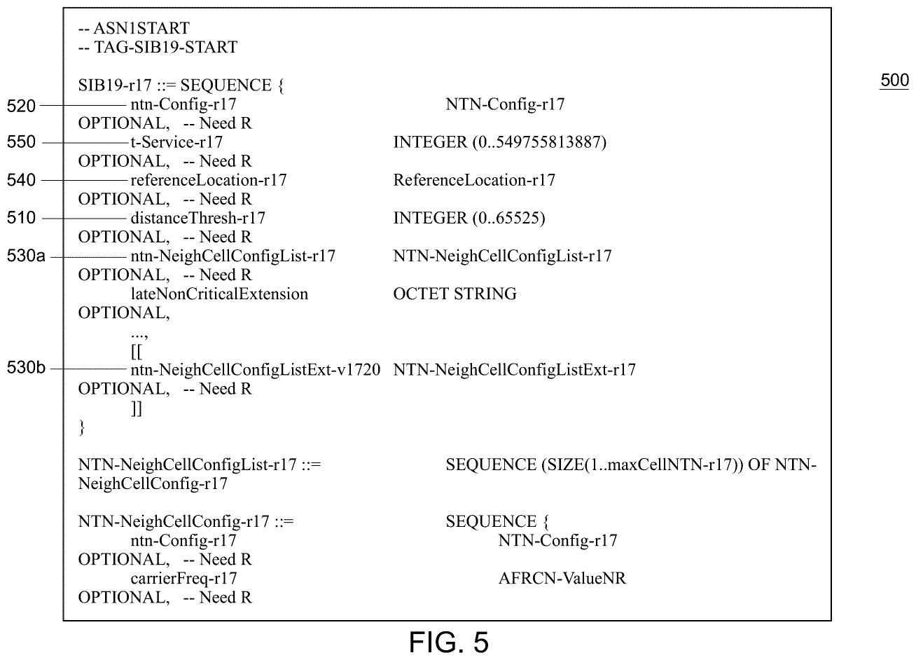

Turning now to FIG. 5, a system information block 500 containing satellite assistance information for non-terrestrial network access is provided in accordance with previous embodiments. The system information block 500 is an SIB19 information element.

System information block 500 includes reference field 510 distanceThresh. Reference field 510 describes the distance from the serving cell reference location and is used in location based measurement initiation for radio resource control idle mode and radio resource control active mode. Each step represents 50 meters.

System information block 500 includes reference field 520 ntn-Config. Reference field 520 provides parameters needed for a user equipment to access new radio via non-terrestrial network access such as Ephemeris data, common timing advance parameters, k_offset, and validity duration for uplink synchronization information and epoch.

System information block 500 includes reference fields 530a ntn-NeighCellConfigList and 530b ntn-NeighCellConfigListExt. Reference fields 530a and 530b provide a list of non-terrestrial network neighbor cells including their non-terrestrial network configuration, carrier frequency, and physical cell identifier. If the non-terrestrial network configuration is absent for an entry in reference field 530b, the non-terrestrial network configuration provided in the entry at the same position in reference field 530a applies. The non-terrestrial configuration for the first entry of reference field 530a is provided by the network. If the non-terrestrial configuration is absent for any other entry in reference field 530a, the non-terrestrial configuration provided in the previous entry of reference field 530a applies.

System information block 500 includes reference field 540 referenceLocation. Reference field 540 describes the reference location of the serving cell provided via non-terrestrial network quasi-earth fixed system and is used in location based measurement initiation in radio resource control idle mode and radio resource control inactive mode.

System information block 500 includes reference field 550 t-Service. Reference field 550 indicates the time information on when a cell provided via a non-terrestrial network quasi-earth fixed system is going to stop serving the area it is currently covering. The field indicates a time in multiples of 10 ms after 00:00:00 on Gregorian calendar date 1 Jan. 1900 (midnight between Sunday, Dec. 31, 1899 and Monday, Jan. 1, 1900). The exact stop time is between the time indicated by the value of this field minus one and the time indicated by the value of this field.

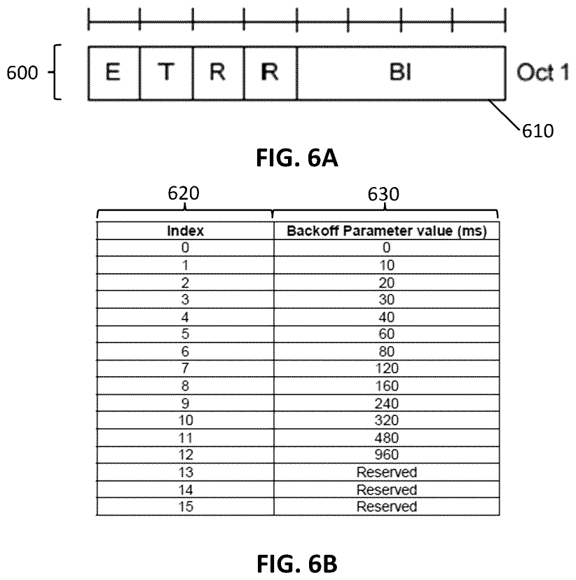

Turning now to FIG. 6A, a medium access control element 600 used for random access channel re-attempt is illustrated in accordance with previous embodiments. If random access channel access fails due to, for example, another user equipment accessing the same random access channel resources, the user equipment receives a re-authorization request from the network, but the random access preamble identifier may not be for it. It is probable here that a backoff indicator value transmitted with a re-authorization request to control the physical random access channel retransmission timing.

The backoff indicator 610 is provided to indicate when the user equipment perform a random access channel re-attempt. The illustrated backoff indicator 610 is for long term evolution, but the same principles apply for new radio. Backoff indicator 610 is a sub-header that carries the time delay between a physical random access channel and the next physical random access channel. Backoff indicator 610 is illustrated as made of 4 bits, implying that it may carry the value from 0˜15. Each value maps to a specific time illustrated in FIG. 6B.

Turning now to FIG. 6B, a table is illustrated showing the correlation between the backoff indicator field value 620 and the backoff parameter value 630. For example, if the backoff indicator field value 620 is 10, the backoff parameter value 630 is 320 ms. This means that a user equipment may send physical random access channel any time between 0 and 320 ms from now.

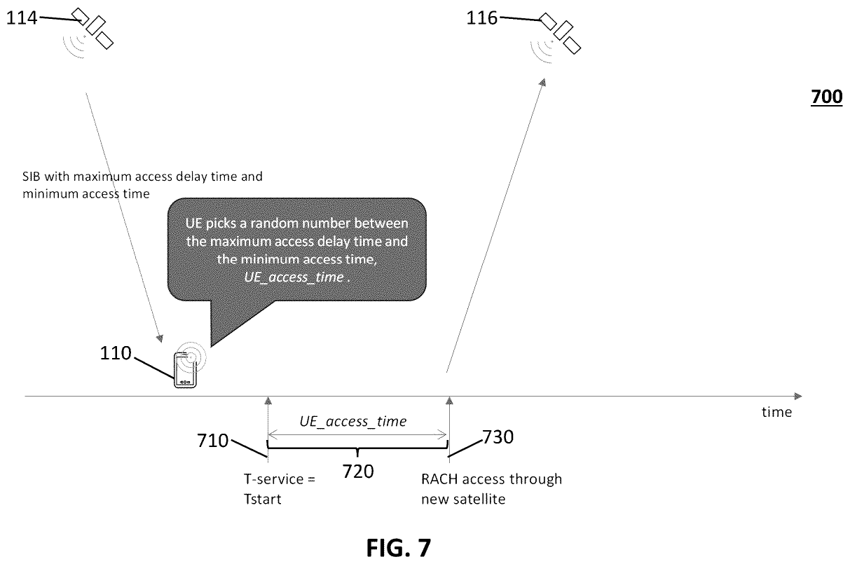

Turning now to FIG. 7, an illustration 700 of a user equipment accessing a target satellite at a particular access time is provided in accordance with example embodiments of the present disclosure;

In one or more embodiments, user equipment 110 is connected to source satellite 114. However, in some examples, the source satellite 114 may be moving away from user equipment 110. In other examples, the user equipment 110 may be moving away from source satellite 114. In these examples, there is a need for user equipment to switch from source satellite 114 to target satellite 116. In some examples, user equipment 110 may need to perform random access channel access of the target satellite 116. In some examples, target satellite 116 may be connected to a common network node with source satellite 114, and in other examples, target satellite 116 may be connected to a different network node (e.g., with transparent or regenerative architecture) than source satellite 114. For example, user equipment 110 may not be capable of performing random access channel-less access. In other examples, a user equipment 110 may be able to perform random access channel-less access but choose to perform random access channel-based access. For example, user equipment 110 may choose to perform random access channel-based access after experiencing a random access channel-less access failure (due to e.g., user equipment not receiving a configured grant, a target cell not being available at a first configured grant occasion, poor network resource allocation, bad radio link conditions, reference signal received power falling below a threshold, and/or the like). In some examples, a network node connected to source satellite 114 may know a proportion of user equipment devices performing random access channel-based access, and in other examples, the network node does not have this knowledge. In some examples, the network node knows roughly the percentage of user equipment devices with random access channel-less capability.

In one or more embodiments, source satellite 114 transmits, to user equipment 110, a system information block that contains target satellite switching related parameters (i.e., system information block 19). In some examples, the system information block includes an indicator of a random access channel opportunity window 720. For example, the system information block may indicate a maximum access delay time describing the maximum time that user equipment 110 has to access target satellite 116 after a satellite switching time. Alternatively, the system information block may indicate a maximum time that user equipment 110 may access target satellite 116 before a satellite switching time. In some examples, the system information block indicates a number of random access channel opportunities rather than a time window. In some examples, at least one opportunity is associated with a user equipment identifier assigned to the user equipment 110.

In some examples, the satellite switching time is a service stop time 710 associated with the source satellite 114. For example, at service stop time 710, the user equipment 110 is no longer in a coverage area of source satellite 114. In other examples, the satellite switching time is a service start time associated with the target satellite 116. For example, at a service start time, user equipment 110 enters a coverage area of target satellite 116.

In some examples, the system information block further indicates a minimum access time after the satellite switching time. For example, the system information block may indicate an extra delay to be added in order to avoid access right after a satellite switching time.

In some examples, the random access channel opportunity window 720 is assigned to a group of user equipment devices. For example, higher priority user equipment groups may get a shorter or earlier random access channel opportunity window 720 than lower priority user equipment groups. For example, higher priority user equipment groups may get a lower maximum access delay time than lower priority user equipment groups. In further examples, different user equipment groups may be assigned different minimum access times. In further examples, different random access channel opportunities within the random access channel opportunity window 720 may be associated with different user equipment identifiers (i.e., different values for the last digit(s) of the call radio network temporary identifier map to different random access channel opportunities).

In one or more embodiments, the user equipment 110 reads the system information block. For example, the user equipment 110 may read a maximum access delay time from the system information block. In further examples, the user equipment 110 may read a minimum access time from the system information block. In some examples, the user equipment 110 may read a maximum access delay time and/or minimum access time that is assigned to the user equipment 110 or a group of user equipment devices including the user equipment 110.

In one or more embodiments, the user equipment 110 determines an access time that is uniform distributed random time (i.e., UE_access_time) within the random access channel opportunity window 720 (e.g., between a minimum access time and a maximum access delay time). In some examples, the user equipment accesses the target satellite 116 at this time. In some examples, by uniformly distributing random access channel access times, random access channel resources are distributed over time. For example, this may avoid a random access channel storm from too many user equipment devices performing random access channel-based access at once. In some examples, rather than a uniform distributed random time, the user equipment 110 determines the access time using a determination method which is preconfigured by the user equipment 110. In some examples, rather than a uniform distributed random time the user equipment 110 determines the access time using a determination method which is provided by a network node through target satellite 114. In some examples, the access time within a random access channel opportunity window (e.g., before or after a satellite switching time).

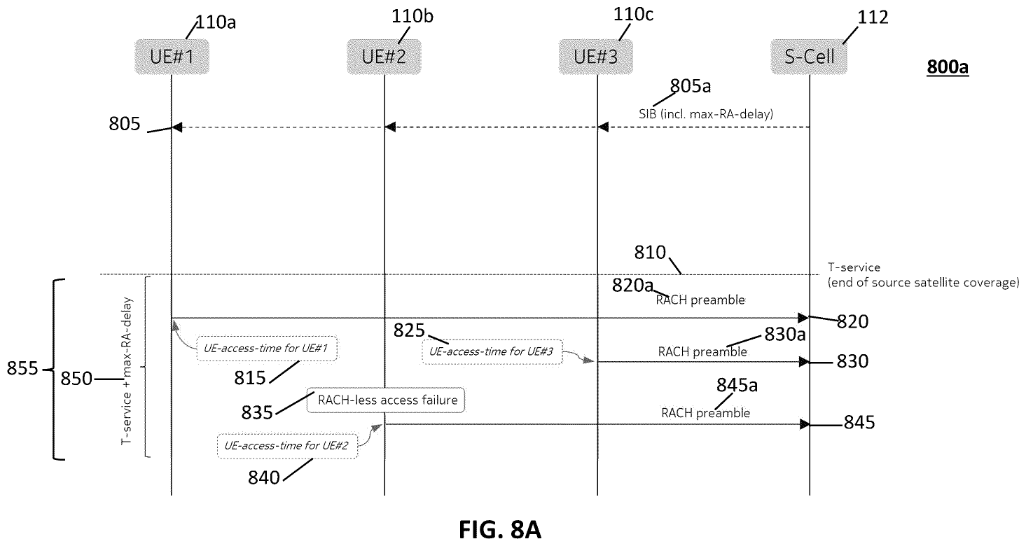

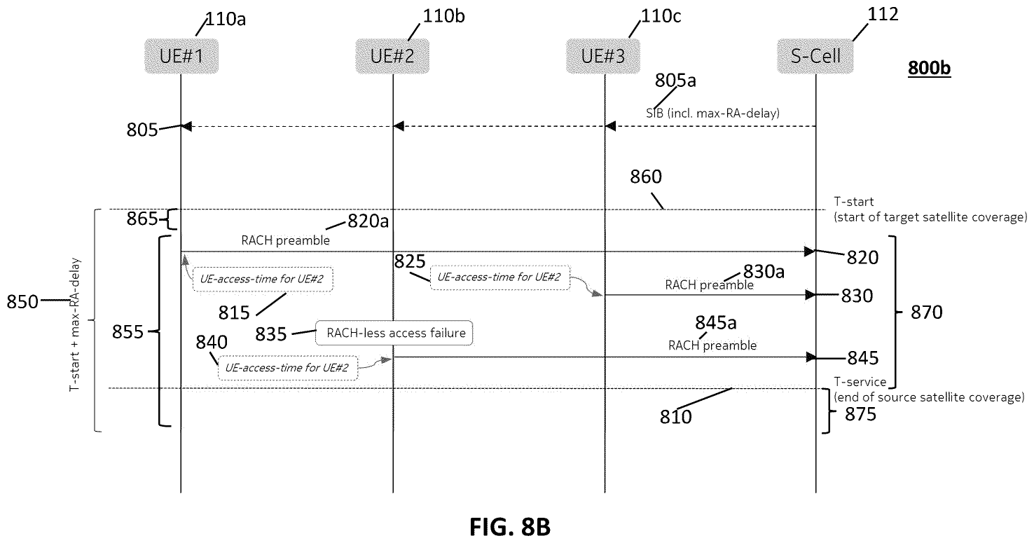

Turning now to FIG. 8A, a flow diagram 800a of system information block-based random access with a hard-satellite switching in accordance with example embodiments of the present disclosure. In one or more embodiments, flow diagram 800a illustrates a group of user equipment devices 110a-c performing a hard satellite switching between a source satellite and a target satellite. In this example embodiment, the source satellite and the target satellite have a transparent structure and are connected to a common network node 112. However, in other examples, the source satellite and target satellite may be connected to separate network nodes (e.g., network nodes 112 and 115) with a transparent structure or a regenerative structure (i.e., the network nodes being onboard the satellites).

In one or more embodiments, at operation 805, the network node transmits, through a source satellite, a system information block 805a to user equipment devices 110a-c. In some examples, the system information block 805a indicates a random access channel opportunity window 855. In some examples, the random access channel opportunity window 855 is indicated by identifying a service stop time 810 associated with the source satellite and a maximum delay time 850 in which the user equipment devices 110a-c may perform the satellite switching after the service stop time 810. In other examples, the random access channel opportunity window 855 may be begin at a service start time associated with the target satellite. In still further examples, the system information block may identify a gap time (i.e., minimum delay time) after the service stop time 810 or service start time before the random access channel opportunity window 855 begins. In some examples, requirements for maximum interruption delay are modified to encompass the random access channel opportunity window 855.

In this example, user equipment devices 110a and 110c determine to perform random access channel-based access. In this example, user equipment device 110b determines to initially perform random access channel-less access. In one or more embodiments, user equipment devices 110a and 110c determine uniform random access times 815 and 825, respectively, within the random access channel opportunity window 855. In one or more embodiments, this saves random access channel resources by allowing user equipment devices 110a and 110c to perform random access channel-based access at different times. In other examples, access times 815 and 825 may be determined using a determination method preconfigured by the user equipment 110 or provided by network node 112.

In one or more embodiments, at operation 820, user equipment 110a performs random access based-access to network node 112 through the target satellite. For example, user equipment 110a transmits a random access preamble 820a to access network node 112 through the target satellite at access time 815.

In one or more embodiments, at operation 830, user equipment 110c performs random access based-access to network node 112 through the target satellite. For example, user equipment 110c transmits a random access preamble 840a to access network node 112 through the target satellite at access time 825.

In one or more embodiments, at operation 835, user equipment 110b is unsuccessful in a random access channel-less access attempt. For example, user equipment 110b may experience a random access channel-less access failure due to user equipment 110b not receiving a configured grant, a target cell not being available at a first configured grant occasion, poor network resource allocation, bad radio link conditions, reference signal received power falling below a threshold, and/or the like. In one or more embodiments, user equipment 110b then determines that random access channel opportunity window 855 is still ongoing. In response, the user equipment 110b then determines a uniform distributed random time 840 between the time when the random access channel-less access failure 835 was detected and the end of the random access channel opportunity 855. In other embodiments, time 840 may be determined using a determination method preconfigured by the user equipment 110 or provided by network node 112. In alternative examples, the random access channel opportunity window 855 may be delayed until the time of a random access channel-less access failure.

In one or more embodiments, at operation 845, user equipment 110b performs random access based-access to network node 112 through the target satellite. For example, user equipment 110b transmits a random access preamble 845a to access network node 112 through the target satellite at access time 840.

Turning now to FIG. 8B, a flow diagram 800b of system information block-based random access with a soft-satellite switching in accordance with example embodiments of the present disclosure. In one or more embodiments, flow diagram 800b illustrates a group of user equipment devices 110a-c performing a soft satellite switching between a source satellite and a target satellite. In this example embodiment, the source satellite and the target satellite have a transparent structure and are connected to a common network node 112. However, in other examples, the source satellite and target satellite may be connected to separate network nodes (e.g., network nodes 112 and 115) with a transparent structure or a regenerative structure (i.e., the network nodes being onboard the satellites).

In one or more embodiments, at operation 805, the network node transmits, through a source satellite, a system information block 805a to user equipment devices 110a-c. In some examples, the system information block 805a indicates a random access channel opportunity window 855. In some examples, the random access channel opportunity window 855 is indicated by identifying a service start time 860 associated with the target satellite and a maximum delay time 850 in which the user equipment devices 110a-c may perform the satellite switching after the service start time 860. In this example, the random access channel opportunity window 855 begins after a gap time 865 after the service start time 860. In some examples, the random access channel opportunity window 855 may be identified by a service stop time 810 associated with the source satellite, an maximum time 870 in which the user equipment devices 110a-c may perform the satellite switching before the service stop time 810, and a maximum delay time 875 in which the user equipment devices 110a-c may perform the satellite switching after the service stop time 810 if they do not perform the satellite switching before the service stop time 810. In some examples, maximum delay time 875 extends past another referenced point in time. In some examples, requirements for maximum interruption delay are modified to encompass the random access channel opportunity window 855.

In this example, user equipment devices 110a and 110c determine to perform random access channel-based access. In this example, user equipment device 110b determines to initially perform random access channel-less access. In one or more embodiments, user equipment devices 110a and 110c determine uniform random access times 815 and 825, respectively, within the random access channel opportunity window 855. In one or more embodiments, this saves random access channel resources by allowing user equipment devices 110a and 110c to perform random access channel-based access at different times. In other examples, access times 815 and 825 may be determined using a determination method preconfigured by the user equipment 110 or provided by network node 112.

In one or more embodiments, at operation 820, user equipment 110a performs random access based-access to network node 112 through the target satellite. For example, user equipment 110a transmits a random access preamble 820a to access network node 112 through the target satellite at access time 815.

In one or more embodiments, at operation 830, user equipment 110c performs random access based-access to network node 112 through the target satellite. For example, user equipment 110c transmits a random access preamble 840a to access network node 112 through the target satellite at access time 825.

In one or more embodiments, at operation 835, user equipment 110b is unsuccessful in a random access channel-less access attempt. For example, user equipment 110b may experience a random access channel-less access failure due to user equipment 110b not receiving a configured grant, a target cell not being available at a first configured grant occasion, poor network resource allocation, bad radio link conditions, reference signal received power falling below a threshold, and/or the like. In one or more embodiments, user equipment 110b then determines that random access channel opportunity window 855 is still ongoing. In response, the user equipment 110b then determines a uniform distributed random time 840 between the time when the random access channel-less access failure 835 was detected and the end of the random access channel opportunity 855. In other embodiments, time 840 may be determined using a determination method preconfigured by the user equipment 110 or provided by network node 112. In alternative examples, the random access channel opportunity window 855 may be delayed until the time of a random access channel-less access failure.

In one or more embodiments, at operation 845, user equipment 110b performs random access based-access to network node 112 through the target satellite. For example, user equipment 110b transmits a random access preamble 845a to access network node 112 through the target satellite at access time 840.

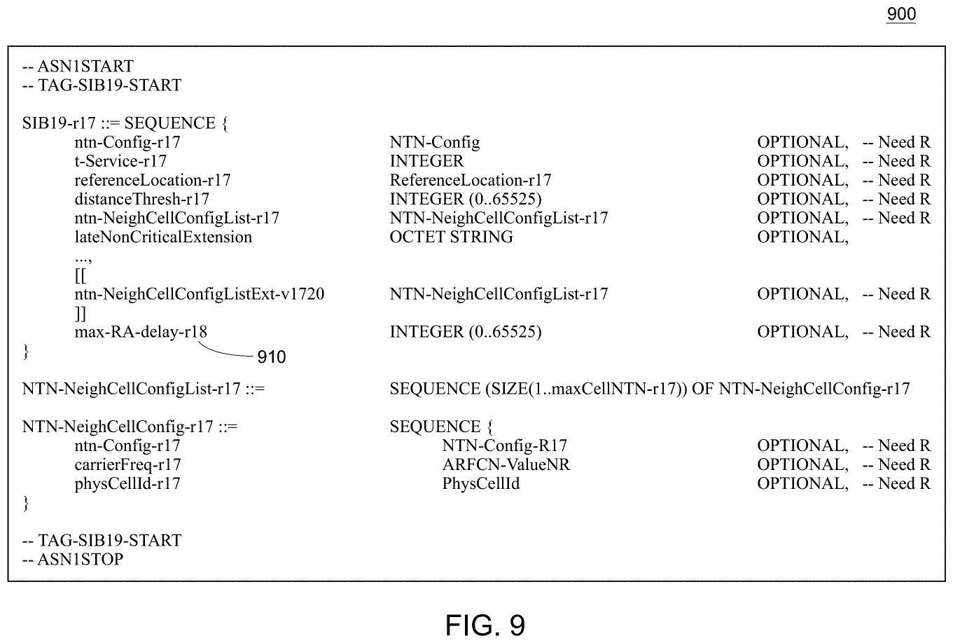

Turning now to FIG. 9, a system information block 900 indicating a random access channel opportunity window is provided in accordance with example embodiments of the present disclosure. In one or more embodiments, reference field 910 indicates the random access channel opportunity window. For example, reference field 910 may indicate the random access channel opportunity window by indicating a maximum delay time in which a user equipment may perform random access channel-based access after a satellite switching time.

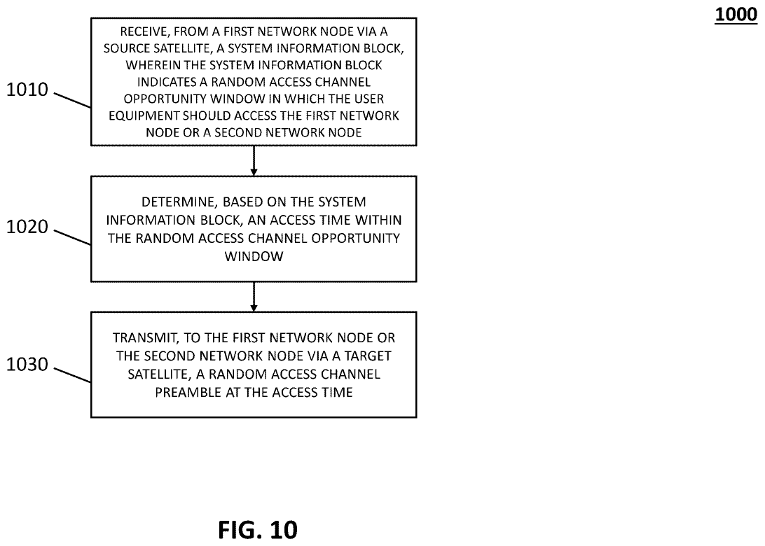

Turning now to FIG. 10, an example flowchart is illustrated for a process 1000 performed by an apparatus embodied by, associated with or otherwise in communication with (hereinafter generally referenced as being embodied by) a user equipment (110) in order to transmit a random access channel preamble at an access time.

As shown in block 1010 of FIG. 10, the apparatus embodied by the user equipment (110) includes means, such as the processing circuitry (220), the communication interface (260), or the like, for receiving (805), from a first network node (112) via a source satellite, a system information block (805a), wherein the system information block (805a) indicates a random access channel opportunity window (855) in which the user equipment (110a/110b/110c) should access the first network node (112) or a second network node. In one or more embodiments, the random access channel opportunity window (855) includes a maximum delay time (850) during which the user equipment (110a/110b/110c) accesses the first network node (112) or the second network node after a satellite switching time (810/860), the satellite switching time (810/860) being one of a service stop time (810) associated with the source satellite or a service start time (860) associated with the target satellite. In one or more embodiments, the random access channel opportunity window (855) begins at a minimum delay time (865) after the satellite switching time (810/860). In one or more embodiments, the random access channel opportunity window (855) includes a maximum time (870) the user equipment (110a/110b/110c) may access the first network node (112) or the second network node before a service stop time (810) associated with the source satellite. In one or more embodiments, the random access channel opportunity window (855) ends at a maximum delay time (850/875) after the service stop time (810) or a service start time (860) associated with the target satellite. In one or more embodiments, the random access channel opportunity window (855) is assigned to a particular group of user equipment devices including the user equipment (110a/110b/110c). In one or more embodiments, the random access channel opportunity window (855) includes a plurality of random access channel opportunities for performing random access channel-based access. In one or more embodiments, at least one random access channel opportunity of the plurality of random access channel opportunities is associated with a user equipment identifier assigned to the user equipment (110a/110b/110c).

As shown in block 1020 of FIG. 10, the apparatus embodied by the user equipment (110) includes means, such as the processing circuitry (220), the communication interface (260), or the like, for determining, based on the system information block (805a), an access time (815/825/840) within the random access channel opportunity window (855). In one or more embodiments, the access time (815/825/840) is a uniform distributed random time within the random access channel opportunity window (855). In one or more embodiments, the access time (815/825/840) is determined by a determination method which is preconfigured by the user equipment (110a/110b/110c). In one or more embodiments, the random access channel opportunity window (855) is delayed based on a time instant of the random access channel-less access failure (835).

As shown in block 1030 of FIG. 10, the apparatus embodied by the user equipment (110) includes means, such as the processing circuitry (220), the communication interface (260), or the like, for transmitting (820/830/845), to the first network node (112) or the second network node via a target satellite, a random access channel preamble (820a/830a/845a) at the access time (815/825/840). In one or more embodiments, the user equipment (110b) determines the access time (840) and transmits (820/830/845) the random access channel preamble (820a/830a/845a) in response to a random access channel-less access failure (835).

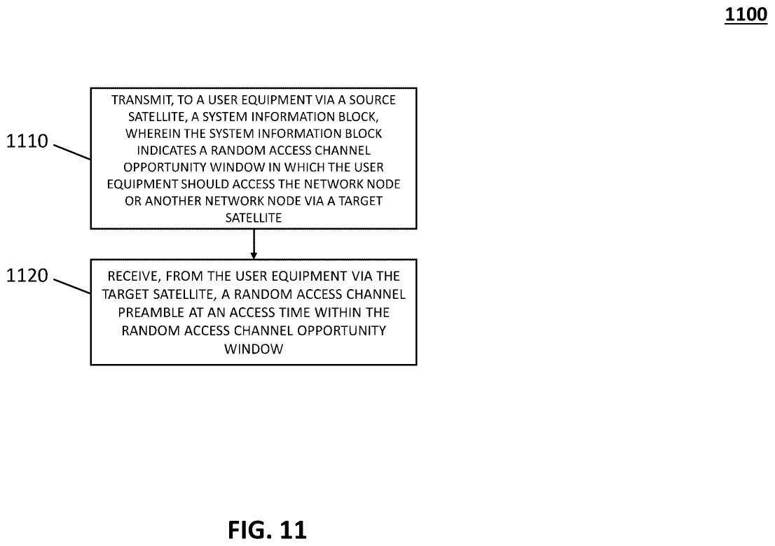

Turning now to FIG. 11, an example flowchart is illustrated for a process 1100 performed by an apparatus embodied by, associated with or otherwise in communication with (hereinafter generally referenced as being embodied by) a network node (112) in order to receive a random access channel preamble at an access time.

As shown in block 1110 of FIG. 11, the apparatus embodied by the network node (112) includes means, such as the processing circuitry (220), the communication interface (260), or the like, for transmitting (805), to a user equipment (110a/110b/110c) via a source satellite, a system information block (805a), wherein the system information block (805a) indicates a random access channel opportunity window (855) in which the user equipment (110a/110b/110c) should access the network node (112) or another network node via a target satellite (116). In one or more embodiments, the random access channel opportunity window (855) includes a maximum delay time (850) during which the user equipment (110a/110b/110c) accesses the network node (112) or the second network node after a satellite switching time (810/860), the satellite switching time (810/860) being one of a service stop time (810) associated with the source satellite or a service start time (860) associated with the target satellite (112). In one or more embodiments, the random access channel opportunity window (855) begins at a minimum delay time (865) after the satellite switching time (810/860). In one or more embodiments, the random access channel opportunity window (855) includes a maximum time (870) the user equipment (110a/110b/110c) may access the network node (112) or the other network node before a service stop time (810) associated with the source satellite. In one or more embodiments, the random access channel opportunity window (855) ends at a maximum delay time (850/875) after the service stop time (810) or a service start time (860) associated with the target satellite. In one or more embodiments, the random access channel opportunity window (855) is assigned to a particular group of user equipment devices including the user equipment (110a/110b/110c). In one or more embodiments, the random access channel opportunity window (855) includes a plurality of random access channel opportunities for performing random access channel-based access. In one or more embodiments, at least one random access channel opportunity of the plurality of random access channel opportunities is associated with a user equipment identifier assigned to the user equipment (110a/110b/110c).

As shown in block 1120 of FIG. 11, the apparatus embodied by the network node (112) includes means, such as the processing circuitry (220), the communication interface (260), or the like, for receiving (820/830/845), from the user equipment (110a/110b/110c) via the target satellite, a random access channel preamble (820a/830a/845a) at an access time (815/825/840) within the random access channel opportunity window (855). In one or more embodiments, the access time (815/825/840) is a uniform distributed random time within the random access channel opportunity window (855). In one or more embodiments, the access time (815/825/840) is determined by a determination method which is preconfigured by the user equipment (110a/110b/110c). In one or more embodiments, the network node (112) is further caused to determine a determination method with which the user equipment (110) is to determine the access time (815/825/840), where the determination time is indicated by the system information block (805a). In one or more embodiments, the user equipment (110b) determines the access time (840) and transmits (820/830/845) the random access channel preamble (820a/830a/845a) in response to a random access channel-less access failure (835). In one or more embodiments, the random access channel opportunity window (855) is delayed based on a time instant of with the random access channel-less access failure (835).

FIGS. 10-11 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 240 of an apparatus employing an embodiment and executed by a processor 220. As will be appreciated, any such computer program instructions may be loaded into a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded into a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In one or more embodiments, a user equipment (110a/110b/110c) is provided, including at least one processor and at least one memory storing instructions that, when executed by the processor, cause the user equipment (110a/110b/110c) to receive (805), from a first network node (112) via a source satellite, a system information block (805a), wherein the system information block (805a) indicates a random access channel opportunity window (855) in which the user equipment (110a/110b/110c) should access the first network node (112) or a second network node. The user equipment (110a/110b/110c) is further caused to determine, based on the system information block (805a), an access time (815/825/840) within the random access channel opportunity window (855). The user equipment (110a/110b/110c) is further caused to transmit (820/830/845), to the first network node (112) or the second network node via a target satellite, a random access channel preamble (820a/830a/845a) at the access time (815/825/840).

In one or more embodiments, the random access channel opportunity window (855) includes a maximum delay time (850) during which the user equipment (110a/110b/110c) accesses the first network node (112) or the second network node after a satellite switching time (810/860), the satellite switching time (810/860) being one of a service stop time (810) associated with the source satellite or a service start time (860) associated with the target satellite.

In one or more embodiments, the random access channel opportunity window (855) begins at a minimum delay time (865) after the satellite switching time (810/860).

In one or more embodiments, the random access channel opportunity window (855) includes a maximum time (870) the user equipment (110a/110b/110c) may access the first network node (112) or the second network node before a service stop time (810) associated with the source satellite.

In one or more embodiments, the random access channel opportunity window (855) ends at a maximum delay time (850/875) after the service stop time (810) or a service start time (860) associated with the target satellite.

In one or more embodiments, the random access channel opportunity window (855) is assigned to a particular group of user equipment devices including the user equipment (110a/110b/110c).

In one or more embodiments, the access time (815/825/840) is a uniform distributed random time within the random access channel opportunity window (855).

In one or more embodiments, the access time (815/825/840) is determined by a determination method which is preconfigured by the user equipment (110a/110b/110c).

In one or more embodiments, the user equipment (110b) determines the access time (840) and transmits (820/830/845) the random access channel preamble (820a/830a/845a) in response to a random access channel-less access failure (835).

In one or more embodiments, the random access channel opportunity window (855) is delayed based on a time instant of the random access channel-less access failure (835).

In one or more embodiments, the random access channel opportunity window (855) includes a plurality of random access channel opportunities for performing random access channel-based access.

In one or more embodiments, at least one random access channel opportunity of the plurality of random access channel opportunities is associated with a user equipment identifier assigned to the user equipment (110a/110b/110c).

In one or more embodiments, a network node (112) is provided, including at least one processor and at least one memory storing instructions that, when executed by the processor, cause the network node (112) to transmit (805), to a user equipment (110a/110b/110c) via a source satellite, a system information block (805a), wherein the system information block (805a) indicates a random access channel opportunity window (855) in which the user equipment (110a/110b/110c) should access the network node (112) or another network node via a target satellite (116). Additionally or alternatively, the network node (112) may be caused to receive (820/830/845), from the user equipment (110a/110b/110c) via the target satellite, a random access channel preamble (820a/830a/845a) at an access time (815/825/840) within the random access channel opportunity window (855).

In one or more embodiments, the random access channel opportunity window (855) includes a maximum delay time (850) during which the user equipment (110a/110b/110c) accesses the network node (112) or the second network node after a satellite switching time (810/860), the satellite switching time (810/860) being one of a service stop time (810) associated with the source satellite or a service start time (860) associated with the target satellite (112).

In one or more embodiments, the random access channel opportunity window (855) begins at a minimum delay time (865) after the satellite switching time (810/860).

In one or more embodiments, the random access channel opportunity window (855) includes a maximum time (870) the user equipment (110a/110b/110c) may access the network node (112) or the other network node before a service stop time (810) associated with the source satellite.

In one or more embodiments, the random access channel opportunity window (855) ends at a maximum delay time (850/875) after the service stop time (810) or a service start time (860) associated with the target satellite.

In one or more embodiments, the random access channel opportunity window (855) is assigned to a particular group of user equipment devices including the user equipment (110a/110b/110c).

In one or more embodiments, the access time (815/825/840) is a uniform distributed random time within the random access channel opportunity window (855).

In one or more embodiments, the network node (112) is further caused to determine a determination method with which the user equipment (110) is to determine the access time (815/825/840), where the determination time is indicated by the system information block (805a).

In one or more embodiments, the user equipment (110b) determines the access time (840) and transmits (820/830/845) the random access channel preamble (820a/830a/845a) in response to a random access channel-less access failure (835).

In one or more embodiments, the random access channel opportunity window (855) is delayed based on a time instant of the random access channel-less access failure (835).

In one or more embodiments, the random access channel opportunity window (855) includes a plurality of random access channel opportunities for performing random access channel-based access.

In one or more embodiments, at least one random access channel opportunity of the plurality of random access channel opportunities is associated with a user equipment identifier assigned to the user equipment (110a/110b/110c).

In one or more embodiments, a computer-implemented method is provided that is performed by a user equipment (110a/110b/110c) and includes receiving (805), from a first network node (112) via a source satellite, a system information block (805a), wherein the system information block (805a) indicates a random access channel opportunity window (855) in which the user equipment (110a/110b/110c) should access the first network node (112) or a second network node. The method further includes determining, based on the system information block (805a), an access time (815/825/840) within the random access channel opportunity window (855). The method further includes transmitting (820/830/845), to the first network node (112) or a second network node and through a target satellite, a random access channel preamble (820a/830a/845a) at the access time (815/825/840).

In one or more embodiments, the random access channel opportunity window (855) includes a maximum delay time (850) during which the user equipment (110a/110b/110c) accesses the first network node (112) or the second network node after a satellite switching time (810/860), the satellite switching time (810/860) being one of a service stop time (810) associated with the source satellite or a service start time (860) associated with the target satellite.

In one or more embodiments, the random access channel opportunity window (855) begins at a minimum delay time (865) after the satellite switching time (810/860).

In one or more embodiments, the random access channel opportunity window (855) includes a maximum time (870) the user equipment (110a/110b/110c) may access the first network node (112) or the second network node before a service stop time (810) associated with the source satellite.

In one or more embodiments, the random access channel opportunity window (855) ends at a maximum delay time (850/875) after the service stop time (810) or a service start time (860) associated with the target satellite.

In one or more embodiments, the random access channel opportunity window (855) is assigned to a particular group of user equipment devices including the user equipment (110a/110b/110c).

In one or more embodiments, the access time (815/825/840) is a uniform distributed random time within the random access channel opportunity window (855).

In one or more embodiments, the access time (815/825/840) is determined by a determination method which is preconfigured by the user equipment (110a/110b/110c).

In one or more embodiments, the user equipment (110b) determines the access time (840) and transmits (820/830/845) the random access channel preamble (820a/830a/845a) in response to a random access channel-less access failure (835).

In one or more embodiments, the random access channel opportunity window (855) is delayed based on a time instant of the random access channel-less access failure (835).

In one or more embodiments, the random access channel opportunity window (855) includes a plurality of random access channel opportunities for performing random access channel-based access.

In one or more embodiments, at least one random access channel opportunity of the plurality of random access channel opportunities is associated with a user equipment identifier assigned to the user equipment (110a/110b/110c).

In one or more embodiments, a computer-implemented method is provided that is performed by a network node (112) and includes transmitting (805), to a user equipment (110a/110b/110c) via a source satellite, a system information block (805a), wherein the system information block (805a) indicates a random access channel opportunity window (855) in which the user equipment (110a/110b/110c) should access the network node (112) or another network node, via a target satellite. Additionally or alternatively, the method includes receiving (820/830/845), from the user equipment (110a/110b/110c) via the target satellite, a random access channel preamble (820a/830a/845a) at an access time (815/825/840) within the random access channel opportunity window (855).

In one or more embodiments, the random access channel opportunity window (855) includes a maximum delay time (850) during which the user equipment (110a/110b/110c) accesses the network node (112) or the second network node after a satellite switching time (810/860), the satellite switching time (810/860) being one of a service stop time (810) associated with the source satellite or a service start time (860) associated with the target satellite (112).

In one or more embodiments, the random access channel opportunity window (855) begins at a minimum delay time (865) after the satellite switching time (810/860).

In one or more embodiments, the random access channel opportunity window (855) includes a maximum time (870) the user equipment (110a/110b/110c) may access the network node (112) or the other network node before a service stop time (810) associated with the source satellite.

In one or more embodiments, the random access channel opportunity window (855) ends at a maximum delay time (850/875) after the service stop time (810) or a service start time (860) associated with the target satellite.

In one or more embodiments, the random access channel opportunity window (855) is assigned to a particular group of user equipment devices including the user equipment (110a/110b/110c).

In one or more embodiments, the access time (815/825/840) is a uniform distributed random time within the random access channel opportunity window (855).

In one or more embodiments, method further includes determining a determination method with which the user equipment (110) is to determine the access time (815/825/840), where the determination time is indicated by the system information block (805a).

In one or more embodiments, the user equipment (110b) determines the access time (840) and transmits (820/830/845) the random access channel preamble (820a/830a/845a) in response to a random access channel-less access failure (835).

In one or more embodiments, the random access channel opportunity window (855) is delayed based on a time instant of the random access channel-less access failure (835).

In one or more embodiments, the random access channel opportunity window (855) includes a plurality of random access channel opportunities for performing random access channel-based access.

In one or more embodiments, at least one random access channel opportunity of the plurality of random access channel opportunities is associated with a user equipment identifier assigned to the user equipment (110a/110b/110c).

In one or more embodiments, a non-transitory computer readable storage medium is provided including computer instructions that, when executed by a user equipment (110), cause the user equipment (110) to receive (805), from a first network node (112) via a source satellite, a system information block (805a), wherein the system information block (805a) indicates a random access channel opportunity window (855) in which the user equipment (110a/110b/110c) should access the first network node (112) or a second network node. The user equipment (110a/110b/110c) is further caused to determine, based on the system information block (805a), an access time (815/825/840) within the random access channel opportunity window (855). The user equipment (110a/110b/110c) is further caused to transmit (820/830/845), to the first network node (112) or the second network node via a target satellite, a random access channel preamble (820a/830a/845a) at the access time (815/825/840).

In one or more embodiments, a non-transitory computer readable storage medium is provided including computer instructions that, when executed by a network node (112), cause the network node (112) to transmit (805), to a user equipment (110a/110b/110c) via a source satellite, a system information block (805a), wherein the system information block (805a) indicates a random access channel opportunity window (855) in which the user equipment (110a/110b/110c) should access the network node (112) or another network node via a target satellite. Additionally or alternatively, the network node (112) may be caused to receive (820/830/845), from the user equipment (110a/110b/110c) via the target satellite, a random access channel preamble (820a/830a/845a) at an access time (815/825/840) within the random access channel opportunity window (855).

In one or more embodiments, a user equipment (110a/110b/110c) is provided that includers means for receiving (805), from a first network node (112) via a source satellite, a system information block (805a), wherein the system information block (805a) indicates a random access channel opportunity window (855) in which the user equipment (110a/110b/110c) should access the first network node (112) or a second network node. The user equipment (110a/110b/110c) further includes means for determining, based on the system information block (805a), an access time (815/825/840) within the random access channel opportunity window (855). The user equipment (110a/110b/110c) further includes means for transmitting (820/830/845), to the first network node (112) or the second network node via a target satellite, a random access channel preamble (820a/830a/845a) at the access time (815/825/840).

In one or more embodiments, a network node (112) is provided that includes means for transmitting (805), to a user equipment (110a/110b/110c) via a source satellite, a system information block (805a), wherein the system information block (805a) indicates a random access channel opportunity window (855) in which the user equipment (110a/110b/110c) should access the network node (112) or another network node via a target satellite. Additionally or alternatively, the network node (112) includes means for receiving (820/830/845), from the user equipment (110a/110b/110c) via the target satellite, a random access channel preamble (820a/830a/845a) at an access time (815/825/840) within the random access channel opportunity window (855).

Many modifications and other embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A user equipment, comprising:
at least one processor; and
at least one memory storing instructions that, when executed by the processor, cause the user equipment to perform:
receive, from a first network node via a source satellite, a system information block, wherein the system information block indicates a random access channel opportunity window in which the user equipment should access the first network node or a second network node;
determine, based on the system information block, an access time within the random access channel opportunity window; and
transmit, to the first network node or the second network node via a target satellite, a random access channel preamble at the access time.

2. The user equipment of claim 1, wherein the random access channel opportunity window comprises a maximum delay time during which the user equipment accesses the first network node or the second network node after a satellite switching time, the satellite switching time being one of a service stop time associated with the source satellite or a service start time associated with the target satellite.

3. The user equipment of claim 2, wherein the random access channel opportunity window begins at a minimum delay time after the satellite switching time.

4. The user equipment of claim 1, wherein the random access channel opportunity window comprises a maximum time the user equipment may access the first network node or the second network node before a service stop time associated with the source satellite.

5. The user equipment of claim 4, wherein the random access channel opportunity window ends at a maximum delay time after the service stop time or a service start time associated with the target satellite.

6. The user equipment of claim 1, wherein the random access channel opportunity window is assigned to a particular group of user equipment devices comprising the user equipment.

7. The user equipment of claim 1, wherein the access time is a uniform distributed random time within the random access channel opportunity window.

8. The user equipment of claim 1, wherein the access time is determined by a determination method which is preconfigured by the user equipment.

9. The user equipment of claim 1, wherein the user equipment determines the access time and transmits the random access channel preamble in response to a random access channel-less access failure.

10. The user equipment of claim 9, wherein the random access channel opportunity window is delayed based on a time instant of the random access channel-less access failure.

11. The user equipment of claim 1, wherein the random access channel opportunity window comprises a plurality of random access channel opportunities for performing random access channel-based access.

12. The user equipment of claim 11, wherein at least one random access channel opportunity of the plurality of random access channel opportunities is associated with a user equipment identifier assigned to the user equipment.

13. A network node, comprising:
at least one processor; and
at least one memory storing instructions that, when executed by the processor, cause the network node to perform at least one of:
transmit, to a user equipment via a source satellite, a system information block, wherein the system information block indicates a random access channel opportunity window in which the user equipment should access the network node or another network node via a target satellite; and
receive, from the user equipment via the target satellite, a random access channel preamble at an access time within the random access channel opportunity window.

14. The network node of claim 13, wherein the random access channel opportunity window comprises a maximum delay time during which the user equipment accesses the network node or the other network node after a satellite switching time, the satellite switching time being one of a service stop time associated with the source satellite or a service start time associated with the target satellite.

15. The network node of claim 14, wherein the random access channel opportunity window begins at a minimum delay time after the satellite switching time.

16. The network node of claim 13, wherein the random access channel opportunity window comprises a maximum time the user equipment may access the network node or the other network node before a service stop time associated with the source satellite.

17. The network node of claim 16, wherein the random access channel opportunity window ends at a maximum delay time after the service stop time or a service start time associated with the target satellite.

18. The network node of claim 13, wherein the random access channel opportunity window is assigned to a particular group of user equipment devices comprising the user equipment.

19. The network node of any one of claim 13, wherein the access time is a uniform distributed random time within the random access channel opportunity window.

20. The network node of claim 13, wherein the network node is further caused to determine a determination method with which the user equipment is to determine the access time, wherein the determination time is indicated by the system information block.
